(19) United States
(12) Patent Application Publication
(10) Pub. No.: US 2009/0067039 A1
(43) Pub. Date: Mar. 12, 2009

(54) Optical micro resonator

(76) Inventors: Bernd Nebendahl, Ditzingen (DE); Emmerich Mueller, Aidlingen (DE)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/899,782

(22) Filed: Sep. 7, 2007

(51) Int. Cl. H01S 3/08; B05D 5/06

(52) U.S. Cl. 359/346; 427/162

(57) ABSTRACT

The present invention relates to a micro resonator assembly (16), comprising a body (2) which is covered with a layer (6) of at least one material at least at an intended point of interaction between the micro resonator (4) and an associated coupling element (10, 12) when using the micro resonator (4), whereby the layer (6) has a transparent thickness (8) which corresponds to a desired distance (8) between the micro resonator (4) and an associated coupling element (10, 12) at least at the intended point (14) of interaction, and to a manufacturing process therefor.

### BACKGROUND ART

The present invention relates to an optical micro resonator assembly.

Optical micro resonators are used as a frequency selective element. Such micro resonators are for example used in external laser cavities to select a certain frequency of the laser. Sometimes micro resonators are used to replace etalons as a frequency selective element in optical devices, e.g. in external laser cavities. This is because micro resonators have a higher goodness or quality Q than etalons with respect to the scatter factor. The goodness Q, i.e., the ratio between transmitted optical power and scattered or lost optical power, of an etalon is about 10⁴ whereas Q of a micro resonator is about 10⁹.

A micro resonator normally comprises a body made out of glass. This body of glass can heave the shape of a torus, a disk or a ball. The principle of the function of the micro resonator is to couple a part of the electromagnetic field of the light beam into the body. This part is then resonating on the equator of the body and is kept inside the body due to total internal reflection at the boundary of the body. The length of the equator should be a natural number multiple of the desired wavelength.

To couple the electromagnetic field into the micro resonator normally there are used prisms. These prisms are placed into the path of the light. One of the boundaries of the prism is located very dose to the boundary of the body. The distance between prism and body should be e.g. as low as 700-500 nm but it should never be zero. Although there is total reflection of the light beam at the boundary of the prism and of the microresonator, also, there is an interaction of the evanescent electromagnetic field of the light beam in the prism with the evanescent electromagnetic field of the light beam in the microresonator body.

This interaction can occur due to the short distance between prism and body via the tunnel effect. Because of this interaction about half of the electromagnetic field of the light beam in the prism will be coupled into the body if the strength of the interaction is chosen properly. The strength K of the interaction, i.e., the amount of the electromagnetic field of the light beam in the prism which is coupled into the body is determined by the distance between the focus of the light beam within the prism and the focus of the light beam in the body. A large distance will cause a low K and a short distance will cause a high K.

### DISCLOSURE OF THE INVENTION

It is an object of the invention to provide an improved optical micro resonator assembly and an improved manufacturing process therefor.

The object is solved by the independent claims. Preferred embodiments are shown by the dependent claims.

Embodiments of the invention comprise the perception that there is a trade off between K and Q because with lower distance between prism and body there is a coupling loss which results in a lower effective Q. Therefore, for each desired resonating wavelength and therefore for each size of prism and body there is existing a optimum distance between prism and body. At this distance both Q and K have their optimum values in that sense that for a certain desired coupling strength K the highest possible Q is preserved. This distance can be calculated for a certain wavelength and for a given combination of materials for the prism and the body.

However, due to the small distances of down to 700-500 nm it is extremely difficult and therefore very thorough to manufacture such a distance in a reliable manner since the desired distance must be met within a tolerance of a few nm. Moreover, it is also very thorough to keep such a small distance stable after having finished the manufacturing process.

Therefore, embodiments of the present invention cover the body with a transparent material with lower index of refraction than both prism and body at least at the intended point of interaction between prism and body whereby the material has a thickness at least at the intended point of interaction between prism and body which preferably is exact the desired distance between prism and body at the intended point of interaction between prism and body. This provides the possibility to bring the prism in direct contact with the accordingly coated body. It is therefore much easier to precisely establish and to continuously keep exactly the desired distance between prism and body. Moreover, it is possible to attach the covering transparent layer to the body or the prism to the coated body by using a transparent optical adhesive. Such an adhesive has preferably the same index of refraction than the covering transparent layer.

The provision of the exact thickness with a tolerance of a few nm is possible because of the today's possibility to reliably taking away, e.g. by grinding, transparent material with extreme precision having a tolerance of only a few, e.g. 1-10, nm.

A great advantage of embodiments of the present invention is the protection of the body and the gap at the intended point of interaction between prism and body against any undesired contamination because the gap is not longer filled with air but is filled with a solid material and the whole body is protected from contamination.

Embodiments of the invention can be partly or entirely embodied or supported by one or more suitable software programs, which can be stored on or otherwise provided by any kind of data carrier, and which might be executed in or by any suitable data processing unit. Software programs or routines are preferably applied to the realization of the inventive method.

### BRIEF DESCRIPTION OF THE DRAWINGS

Other objects and many of the attendant advantages of embodiments of the present invention will be readily appreciated and become better understood by reference to the following more detailed description of embodiments in connection with the accompanied drawings. Features that are substantially or functionally equal or similar will be referred to with the same reference sign(s).

FIG. 1 to 5 show schematic illustrations of embodiments of the present invention.

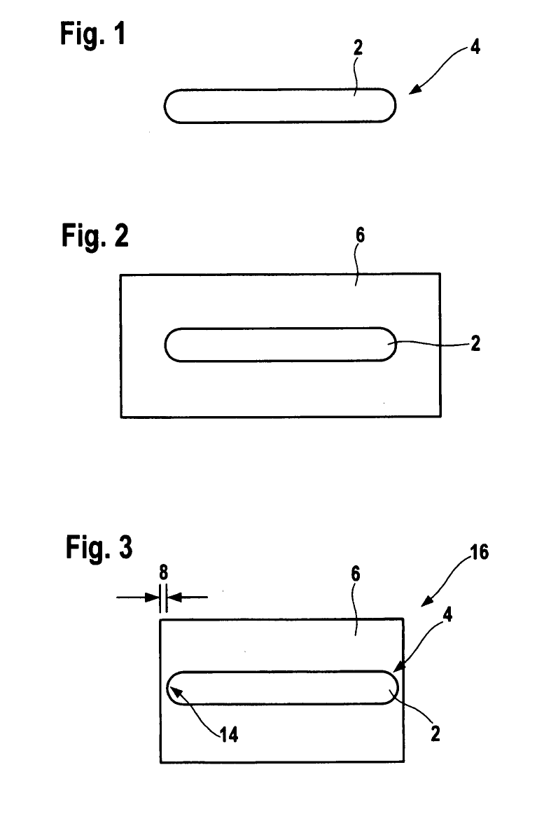

FIG. 1 shows a schematic illustration of a body 2 of an optical micro resonator 4. In FIG. 1 body 2 is shown in a side view. Body 2 is made out of glass and has the shape of a disk so that in the following body 2 is also referred to as disk 2. Disk 2 is shown in FIGS. 1-3, 4b and 5 in a side view along the plane of disk 2. The size of disk 2 is chosen in a way so that the length of the equator of the body 2 is a natural number multiple of the desired wavelength which should resonate on the equator of the body 2.

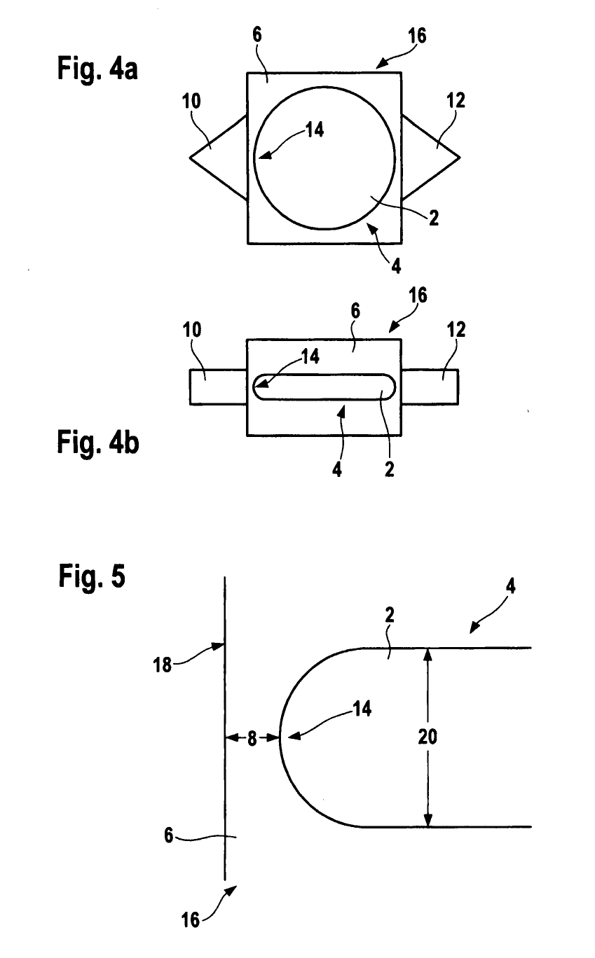

According to an embodiment of the inventive manufacturing process for manufacturing a micro resonator assembly 16 (see FIG. 3) body 2 is then covered, e.g. by vapor deposition, with at least one layer 6 of a transparent material with lower index of refraction than body 2. In the embodiment of FIG. 2 body 2 has an index of refraction of 1.5 whereas the transparent material 6 has an Index of refraction of 1.3. In the embodiment in FIG. 2 the transparent material 6 is made out of a polymer. Moreover, it is possible to attach the covering transparent layer 6 to the body by using a not shown transparent optical adhesive having preferably the same index of refraction than the covering transparent layer 6.

According to be aforementioned embodiment of the inventive manufacturing process for manufacturing a micro resonator assembly 16 layer 6 is taken away down to a transparent thickness which corresponds to a desired distance between the micro resonator 4 and an associated coupling element 10, 12 (see FIGS. 4a and 4b) at least at the intended point 14 of interaction between the micro resonator 4 and an associated coupling element 10, 12 when using the micro resonator 4 as a frequency selective element. By the aforementioned process it is provided an embodiment 16 of a micro resonator assembly as shown in FIG. 3. In the micro resonator assembly 16 of FIG. 3 the transparent thickness 8 is 700 nm with a tolerance of +/−10 nm.

The step of taking away the layer 6 down to the transparent thickness 8 can be done by any possible method, e.g. by grinding. Since it is possible today to preform such a grinding process with extreme precision it is possible to provide the exact desired transparent thickness 8 with the aforementioned tolerance within 10 nm or less.

In FIG. 5 it is shown a more detailed view of the Intended point of interaction 14 and of the layer 6 on point 14. It can be seen that body 2 of micro resonator 4 of the micro resonator assembly 16 is still protected by the polymer layer 6. Therefore body 2 is protected against any undesired contamination. Moreover, a contact surface 18 of layer 6 Is provided at the intended point of interaction 14 by the aforementioned embodiment of the inventive manufacturing process. The contact surface 18 has dimensions that are in the order of a diameter 20 of body 2 of the micro resonator assembly 16. Therefore it is very easy to provide the micro resonator assembly 16 with the associated coupling elements 10, 12 as shown in FIGS. 4a and 4b. According to the embodiment shown in FIGS. 4a and 4b the coupling elements 10, 12 are prisms. FIG. 4a is a top view of the assembly 16 whereas FIG. 4b is a side view. FIG. 4a and 4b show the triangular shape of prisms 10, 12 and how the prisms 10, 12 are attached to the surface 18 of the layer 6.

The aforementioned distance 8 is chosen in a way that for the desired resonating wavelength and for the chosen size of prisms 10, 12 both Q and K have their optimum values in that sense that for a certain desired coupling strength K the highest possible Q is preserved. In the embodiment of FIGS. 4a and 4b prisms 10, 12 are made of Cerodur and have both a refractive index which is the same refractive index as the refractive of body 2, e.g. a refractive index of 1.5.

The optimum thickness depends, among others, on the actual shape of the rim of the body, the ratio of absorption, volume and surface scattering and radiation losses of the micro resonator and a plurality of further parameters.

One possibility to determine an optimum distance 8 is performing a measurement in vacuum and to determine the coating distance analytically. For a special case that the indices or refraction of the body 2 and the prisms 10 and 12 are equal, the following formula can be used therefore:

$$r = \frac{\sqrt{{sin}^{2} ( θ ) {n}_{1}^{2} - 1}}{{n}_{2} \sqrt{\frac{{sin}^{2} ( θ ) {n}_{1}^{2}}{{n}_{2}^{2}} - 1}}$$

wherein:

θ is the angle of the incident beam,

n₁ is the index of refraction of the body and the prisms,

n₂ is the index of coating, and

r is the ratio of optimum thickness of the coating and thickness of vacuum (air) gap, always larger than 1

1. A method for manufacturing a micro resonator assembly, comprising:
covering a body of a micro resonator at least at an intended point of optical interaction between the micro resonator and an associated coupling element with a layer of at least one material, and
taking away a portion of the layer down to a transparent thickness which corresponds to a desired distance between the micro resonator and an associated coupling element at least at the intended point of optical interaction.

2. The method of claim 1, further comprising:
covering the body of the micro resonators at least at the intended point of optical interaction with a layer of a first material with a thickness which corresponds to the desired distance between the micro resonator and an associated coupling element at least at the intended point of interaction,
covering the body of the micro resonator with a second material, and
taking away a portion of the second material down to a thickness of zero at least at the intended point of interaction.

3. The method of claim 1, wherein taking away the material comprises grinding of the material.

4. The method of claim 1, wherein covering the body comprises a chemical vapor deposition process.

5. The method of claim 1, wherein the refractive index of the associated coupling element is substantially equal to the refractive index of the body and the refractive indices of the body and the associated coupling element are both greater than the refractive index of the layer.

6. The method of claim 1, wherein the refractive index of the associated coupling element and the refractive index of the body each is about 1.5, and the refractive index of the material in the layer with the transparent thickness is about 1.3.

7. The method of claim 1, wherein the body is covered by the layer by using a transparent optical adhesive.

8. A software program or product, stored on a computer readable medium, for controlling the method of claim 1, when run on a data processing system such as a computer.

9. A micro resonator assembly comprising:
a body which is covered with a layer of at least one material at least at one point of optical interaction between the micro resonator and an associated coupling element,
wherein at the point of optical interaction the layer has a relative minimum thickness, preferably as result of taking away a portion of the layer, so that at the point of optical interaction, the layer has a thickness which corresponds to a desired distance between the micro resonator and the associated coupling element.

10. The assembly of claim 9, wherein a contact surface between the body and the coupling element has a dimension that is in the order of the diameter of the body.

11. The assembly of claim 9, wherein the body is at least partly made out of glass, the coupling element at least partly is made out of cerodur, and the material of the layer at least partly comprises a polymer.
